(19) United States
(12) Patent Application Publication
(10) Pub. No.: US 2008/0024524 A1
(43) Pub. Date: Jan. 31, 2008

(54) Visualization of medical image data at actual size

(76) Inventors: Eckhard Hempel, Furth (DE); Matthias Thorn, Mohrendorf (DE)

Correspondence Address: HARNESS, DICKEY & PIERCE, P.L.C., P.O.BOX 8910, RESTON, VA, 20195, US

(21) Appl. No.: 11/878,094

(22) Filed: Jul. 20, 2007

(30) Foreign Application Priority Data
Jul. 25, 2006 (DE) 10 2006 034 360.3

(51) Int. Cl. G09G 5/00

(52) U.S. Cl. 345/660

(57) ABSTRACT

At least one embodiment of the invention relates to the display of image data collected for medical purposes at actual object size, in particular to a device, a method and/or a computer program for driving a display unit. In at least one embodiment, the device for driving a display unit that can be connected to the device is designed to display a section of image data, recorded for medical purposes, of an object by way of the display unit, the display unit and the image data each having a field of view, the field of view of the display unit being smaller than the field of view of the image data, and the object sizes represented in the section being equal to the actual object sizes.

### PRIORITY STATEMENT

The present application hereby claims priority under 35 U.S.C. §119 on German patent application number DE 10 2006 034 360.3 filed Jul. 25, 2006, the entire contents of which is hereby incorporated herein by reference.

### FIELD

Embodiments of the invention generally relate to the display of image data collected for medical purposes at actual object size. For example, embodiments may relate to a device, a method and/or a computer program for driving a display unit.

### BACKGROUND

Image data collected for medical purposes, for example computed tomography pictures of the upper body, generally have a field of view (FOV) that has larger dimensions than the displaying medium, for example a commercially available 17″ monitor. Consequently, any structures of the images are illustrated in a fashion smaller than corresponds to actuality. This has the consequence that a viewer requires experience and the ability to make abstractions in order to extract the actual sizes of the actual anatomy. It is known to equip display devices with a zoom function in order to facilitate the viewer's task. What is involved here is free zooming with zoom factor stipulation relating to the reconstructed image, that is to say when setting the zoom factor the viewer must again rely on his experience, or he must calculate the zoom factor to be set, to which end he has to determine device parameters, and/or to carry out experiments.

### SUMMARY

In at least one embodiment of the present invention, the acquisition of the actual sizes of the anatomy are facilitated for a viewer.

In accordance with at least one embodiment of the present invention, a device is disclosed for driving a display unit that can be connected to the device and is designed to display a section of image data, recorded for medical purposes, of an object by way of the display unit, the display unit and the image data each having a field of view, the field of view of the display unit being smaller than the field of view of the image data, and the object sizes represented in the section being equal to the actual object sizes.

At least one embodiment of the present invention results in an improvement of the work flow of the examiner, since no zoon factor need be calculated in order to view the image at actual size. Owing to the fact that the image data are displayed true to size, the display of the image data corresponds straight away to the expectation of the examiner. These both lead to shorter diagnosis times. Likewise, the present invention enables a better understanding of the image data for nonspecialists, for example nonradiologists such as orthopedists and surgeons.

It is advantageously possible that the ratio of represented object sizes to actual object sizes can be displayed by way of the display unit or a further display unit.

It is advantageously possible that the ratio of represented object sizes to actual object sizes can be input.

The driving of the display unit is advantageously based on representation properties of the display unit that influence the represented object size, that is to say the display size. It is particularly advantageous in this case when the representation properties can be automatically determined. The representation properties advantageously include a pixel size or a relative resolution.

Advantageously, the field of view of the image data, a desired size of image points of the image data, and/or a relative resolution of the image data can be automatically determined, and the driving of the display unit is based on the field of view of the image data, the desired size of image point of the image data, and/or the relative resolution of the image data.

The image data can be advantageously recorded by way of X-ray diagnostic radiography, computed tomography, magnetic resonance tomography, or sonography or by way of a combination of these methods.

The device advantageously has a device for recording the image data.

An overview of the image data can advantageously be displayed together with the section by way of the display unit, the section being identified in the overview. In this case, the overview advantageously shows a sagittal, coronary and/or axial display of the object.

The device advantageously includes the display unit.

Just as in the device for driving a display unit that can be connected to the device, at least one embodiment of the invention can be seen in a method for driving a display unit and in a computer program.

In accordance with at least one embodiment of the invention, the method for driving a display unit has the following step:

displaying a section of image data, recorded for medical purposes, of an object by means of the display unit, the display unit and the image data each having a field of view, the field of view of the display unit being smaller than the field of view of the image data, and the object sizes represented in the section being equal to the actual object sizes.

In accordance with at least one embodiment of the invention the computer program is developed to execute the step of the method for controlling a display unit when loaded into the main memory of a computer.

### BRIEF DESCRIPTION OF THE DRAWINGS

The invention is explained more accurately below with reference to example embodiments with the aid of drawings, in which:

FIG. 1 shows a block diagram of a first example embodiment of the device, and

FIG. 2 shows an abstraction of a representation of the image data.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described. Like numbers refer to like elements throughout. As used herein, the terms “and/or” and “at least one of” include any and all combinations of one or more of the associated listed items.

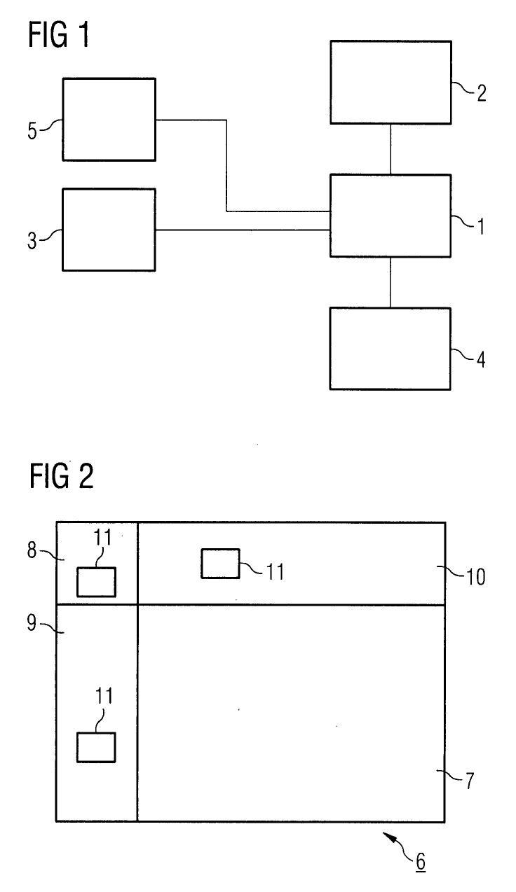

As illustrated in FIG. 1, the example embodiment includes an information processing unit 1, a display unit 2, a recording unit 3 and input device 4. The input device 4 may include, for example, at least one of a keyboard (not illustrated), a computer mouse, trackball, touchpad, joystick or similar, suitable for controlling a cursor, input device (not illustrated), generically termed mouse below.

The recording unit 3 serves for generating image data of an object. The recording principle used for generating the image data can, for example, be given by the method of x-ray diagnostic radiography, computed tomography, magnetic resonance tomography or sonography, for example. The field of view (FOV) of the image data belonging to a recording is given by the dimensions of the region that is covered by the recording. In the case of a recording principle that enables three-dimensional imaging, that is to say in the case of three-dimensional image data, it is customary to represent the image data in slice planes. Consequently, the term field of view is also to be understood as the dimensions of the region, covered by the recording, of a selected slice plane, for example one that is to be or is represented.

The information processing unit 1 receives the image data with associated field of view—directly or indirectly, that is to say via a local communications network—from the recording unit 3. Not shown in FIG. 1 are one or more processors, main memories, interfaces and other elements required for fulfilling the tasks demanded of the information processing unit 1 and self-evident to the person skilled in the art.

Likewise, the information processing unit 1 can read in stored image data 5 with an associated field of view, it being worthy of recommendation here when the image data and the field of view are stored in a common file or are accessible via a common reference.

The field of view can be given directly and indirectly, for example by stipulating one or more reference lengths with reference to which the image data are to be interpreted. The dimensions with which image points—pixels or voxels—of the image data are to be represented, in order to obtain a display that is true to size, constitute such reference lengths. These dimensions are known below as desired size of the image points. Stipulating the desired size of the image points is equivalent to stipulating the relative resolution of the image data, that is to say the stipulation of the image points per length unit. The desired size of the image points and relative resolution can vary for the various dimensions of the image data.

The display unit 2, which is developed for example as commercially available computer monitor is connected to the information processing unit 1. Such monitors are economically priced, but generally cannot represent the complete field of view of the image data at actual size. Thus, even the complete display of a fully grown human forearm on the rectangular field of view provided by a 17″ monitor with a diagonal of 17 inches (43.18 cm) is not possible at actual size. The field of view provided by a display unit is smaller than the field of view of image data if the image data or sectional images of the image data cannot be represented completely at actual size by way of the display unit.

The information processing unit 1 determines representation properties of the display unit 2 that influence the size of representation, for example the pixel size or, in a fashion equivalent thereto, the relative resolution of a monitor, different values being possible for the horizontal and for the vertical. To perform the determination, the information processing unit 1 retrieves the sizes to be determined, or sizes from which the sizes to be determined can be calculated, from the display unit 2. If necessary, to this end the information processing unit 1 sends an appropriate enquiry to the display unit 2.

Alternatively, or in addition, it is possible to identify the connected display unit 2 and then, on the basis of the results of said display identification, to determine the sizes to be determined, or sizes from which the sizes to be determined can be calculated, from a local database or one that can be reached via a communications network. In the case of failure of automatic methods, the exemplary embodiment provides a calibration routine in which the display unit 2 displays a scale that the user has to measure and which has to communicate the measurement result of the information processing unit 1 with the aid of the input device 4.

The information processing unit 1 provides a zoom function on the basis of the determined representation properties of the display unit 2, for example on the basis of the pixel size of a monitor, and on the basis of the desired size of the image points. Here, the user can input with the aid of the input device 4 a zoom factor that describes the ratio of actual object sizes to represented object sizes. This provides support both for inputting a numerical value of the zoom factor via the keyboard, and for inputting the zoom factor with the aid of a symbolic control element that is indicated by means of the display unit 2 and can be operated by mouse. The control element is, for example, a virtual linear regulator. The zoom factor is displayed numerically and/or graphically by way of the display unit 2, it being possible to perform the numerical display by inserting the numerical value over the represented image data, and the graphical display can be given by the control element itself. The standard setting of the zoom factor corresponds to a representation at actual object size.

The information processing unit 1 represents the image data or selected parts of the image data, for example specific slice planes, by way of the display unit 2. When the field of view available is not sufficient to display completely at actual size the field of view of the image data to be represented, only a section of the image data to be represented is shown at actual size. The available field of view can be the field of view of the display unit 2, or else only a part thereof. The latter is the case when parts of the field of view of the display unit 2 are required for another type of display, for example for displaying the zoom factor, the control element, a virtual toolbar, further image data or other views of the image data.

The device provides various display layouts. For example for two-dimensional image data, the display of an overview image together with an image initially at actual size—as per presetting. The image at actual size constitutes the so-called working image. The section of the image data which is displayed in the working image can be selected by the user. The size of representation of the working image can be varied at any time by inputting the zoom factor. The section displayed in the working image is marked in the overview image, for example by a frame.

A layout 6 provided for three-dimensional image data is illustrated in FIG. 2. The layout offers the display of three overview images 8, 9, 10 of the image data together with an image 7 initially at actual size—as per presetting. The image 7 at actual size constitutes the so-called working image 7. The section of the image data that is displayed in the working image 7 can be selected by the user. The size of the representation of the working image 7 can be varied at any time by inputting the zoom factor. The section displayed in the working image 7 is marked in the overview images 8, 9, 10, for example by frames 11. The overview images 8, 9, 10 preferably, but not necessarily, show three orthogonal views of the image data. For example, the overview images 8, 9, 10 show a sagittal 8, a coronary 9 and an axial 10 view of the object. The user can freely select the slice plane to be displayed in the working window 7.

In a further example embodiment, the information processing unit 1 receives no image data from the recording unit 3, but receives appropriate raw-data. In this case, the information processing unit 1 processes the raw data to form image data together with information relating to the field of view. Together with the input device 4 and the display unit 2, the information processing unit 1 in this case also advantageously serves as user interface and as an at least primary control unit of the recording unit 3.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A device for driving a display unit, connectable to the device and designed to display a section of image data, recorded for medical purposes, of an object, the display unit and the image data each having a field of view, the field of view of the display unit being relatively smaller than the field of view of the image data, and sizes of objects represented in the displayed section being equal to actual object sizes.

2. The device as claimed in claim 1, wherein a ratio of represented object sizes to actual object sizes is displayable by way of at least one of the display unit and a further display unit.

3. The device as claimed in claim 1, wherein a ratio of represented object sizes to actual object sizes is inputtable.

4. The device as claimed in claim 1, wherein driving of the display unit is based on representation properties of the display unit that influence the represented object sizes.

5. The device as claimed in claim 4, wherein the representation properties are automatically determinable.

6. The device as claimed in claim 4, wherein the representation properties include at least one of a pixel size and a relative resolution.

7. The device as claimed in claim 1, wherein at least one of the field of view of the image data, a desired size of image points of the image data, and a relative resolution of the image data are automatically determinable, and wherein the driving of the display unit is based on at least one of the field of view of the image data, the desired size of image points of the image data, and the relative resolution of the image data.

8. The device as claimed in claim 1, wherein the image data is recordable by way of at least one of X-ray diagnostic radiography, computed tomography, magnetic resonance tomography, and sonography.

9. The device as claimed in claim 1, further comprising means for recording the image data.

10. The device as claimed in claim 1, wherein an overview of the image data is displayable together with the section by way of the display unit, the section being identified in the overview.

11. The device as claimed in claim 10, wherein the overview shows at least one of a sagittal, coronary and axial display of the object.

12. The device as claimed in claim 1, wherein the device comprises the display unit.

13. A method for driving a display unit, comprising:
displaying a section of image data, recorded for medical purposes, of an object by way of the display unit, the display unit and the image data each having a field of view, the field of view of the display unit being relatively smaller than the field of view of the image data, and object sizes represented in the section being equal to the actual object sizes.

14. A computer program developed to execute the method as claimed in claim 12 when loaded into the main memory of a computer.

15. The device as claimed in claim 2, wherein the ratio of represented object sizes to actual object sizes is inputtable.

16. The device as claimed in claim 5, wherein the representation properties include at least one of a pixel size and a relative resolution.

17. The device as claimed in claim 2, wherein the image data is recordable by way of at least one of X-ray diagnostic radiography, computed tomography, magnetic resonance tomography, and sonography.

18. The device as claimed in claim 8, further comprising means for recording the image data.

19. A computer readable medium including program segments for, when executed on a computer device, causing the computer device to implement the method of claim 1.
